(19) United States
(12) Patent Application Publication
(10) Pub. No.: US 2009/0125188 A1
(43) Pub. Date: May 14, 2009

(54) Method of Determining an Assist Torque Set-Point Value for an Electric Motor Driven Power Steering System

(75) Inventors: Markus Broecker, Grevenbroich (DE); Klaus Genz, Viersen (DE); Klaus Roth, Muelheim (DE)

Correspondence Address: MACMILLAN, SOBANSKI & TODD, LLC, ONE MARITIME PLAZA - FIFTH FLOOR, 720 WATER STREET, TOLEDO, OH, 43604, US

(73) Assignee: TRW AUTOMOTIVE GMBH, Alfdorf (DE)

(21) Appl. No.: 12/268,691

(22) Filed: Nov. 11, 2008

(30) Foreign Application Priority Data
Nov. 13, 2007 (DE) DE 102007054017.7

(51) Int. Cl. B62D 6/00

(52) U.S. Cl. 701/42

(57) ABSTRACT

A method of determining an assist torque set-point value for an electric motor driven power steering system that is a function of a steering torque, a vehicle speed and an angular velocity of the steering system motor.

### CROSS-REFERENCE TO RELATED APPLICATIONS

This application claims priority to German Patent Application No. 10 2007 054 017.7 filed Nov. 13, 2007, the disclosures of which are incorporated herein by reference in their entirety.

### BACKGROUND OF THE INVENTION

The present invention relates to a method of determining an assist torque set-point value for an electric motor driven power steering system.

To provide assistance to a motor vehicle driver in a manual turning of a steering wheel, a servomotor is provided in modern, electric motor driven power steering systems which generates an auxiliary torque or an auxiliary force. In the prior art, relative methods have already been disclosed which implement the assistance by an electric motor in dependence on a vehicle speed. This allows, for example, to set a high power assistance at low speed (e.g., in a parking process) and a lower power assistance at high speed (e.g., when driving on an interstate highway). As an alternative or in addition to the dependence on the vehicle speed, the auxiliary torque or the auxiliary force may also be determined in dependence on a manually applied steering torque which is sensed by a steering torque sensor. Determining the power assistance in dependence on the vehicle speed and/or the steering torque sensed is intended to provide to the driver a steering assist adapted to the specific driving situation and a comfortable steering feel.

### BRIEF SUMMARY OF THE INVENTION

It is an object of the present invention to determine a set-point value for the steering assistance of a power steering system so as to further enhance the steering feel as perceived by the driver.

In accordance with the present invention, this is achieved by a method of determining an assist torque set-point value for an electric motor driven power steering system, which includes the steps of:

(a) sensing a steering torque;

(b) sensing a vehicle speed;

(c) sensing an angular velocity of the steering system electric motor;

(d) determining a characteristic map output quantity from a predefined characteristic map at least as a function of the vehicle speed and the motor angular velocity; and

(e) determining the assist torque set-point value for the power steering system proceeding from the steering torque sensed, taking into account the characteristic map output quantity.

In this method, the assist torque is thus determined not only in dependence on the steering torque and the vehicle speed, but also in dependence on the motor angular velocity. Taking this additional parameter into account results in an enhancement of the steering feel of the driver, which can be illustrated objectively with reference to a Bode plot (cf. FIG. 5).

In one variant of the method, the predefined characteristic map in step (d) is a two-dimensional characteristic map with the vehicle speed and the motor angular velocity as input quantities, a weighting factor being determined as the characteristic map output quantity. This weighting factor is then subsequently multiplied either directly by the value of the steering torque sensed or by an assist torque base value determined from the steering torque sensed, in order to obtain the assist torque set-point value.

In another variant of the method, the predefined characteristic map in step (d) is a three-dimensional characteristic map with the vehicle speed, the motor angular velocity, and the low-frequency portion of the steering torque sensed as input quantities, this low-frequency portion being determined by means of a filtering device that splits up the steering torque into a high-frequency portion and a low-frequency portion.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a sketch which diagrammatically illustrates the determination of a controlling torque for the electric motor of an electric power steering system;

FIG. 2 shows a first variant of the method according to the invention for determining an assist torque set-point value for an electric motor driven power steering system;

FIG. 3 shows a second variant of the method according to the invention for determining an assist torque set-point value for an electric motor driven power steering system;

FIG. 4 shows a third variant of the method according to the invention for determining an assist torque set-point value for an electric motor driven power steering system; and

FIG. 5 shows a Bode plot which illustrates the advantages of the method according to the invention.

### DETAILED DESCRIPTION OF THE INVENTION

In the following, in particular electromechanical steering systems are to be understood by electric motor driven power steering systems. These electromechanical steering systems typically include a motor which assists a manually applied and mechanically transferred manual torque by a controlling torque M_{Total} to actuate steerable wheels of a vehicle.

According to FIG. 1, the controlling torque M_{Total} for the electric motor of an electromechanical steering system is composed of a plurality of components, M₁, M₂, M₃, M₄, these torque components M₁, M₂, M₃, M₄ being generated from predefined input quantities in different processing procedures 10, 12, 14, 16, 18 and being subsequently added up.

For example, a first component M₁ indicates an auxiliary torque which assists the driver in the direction of his steering movement. Decisive input quantities here for determining the first torque component M₁ are a vehicle speed v, a steering torque Mₛₑₙₛ measured by a torque sensor, and a steering rate v_{φ}; in place of the steering rate v_{φ}, a motor angular velocity ω may also be used as an indicator for the steering rate v_{φ}. Since the two quantities can be easily translated into each other by a gear ratio between the electric motor and a steering column, it is irrelevant which quantity is determined directly. It is merely for the sake of simplicity that the motor angular velocity ω will always be indicated as the input quantity below.

A second torque component M₂ is determined from the same input quantities, which brings about an active damping of the steering system by software.

In a third component M₃ an active restoring torque M₃ is taken into account with the aid of the three previously mentioned input quantities v, Mₛₑₙₛ, v_{φ} as well as an additionally sensed steering wheel angle φ. This active restoring process urges the steering system into a position corresponding to a condition of the vehicle driving straight ahead.

Furthermore, a fourth torque component M₄, being established on the basis of the input quantities vehicle speed v and motor angular velocity ω, serves for an inertia compensation of the motor.

In addition to the above-mentioned four torque components M₁, M₂, M₃, M₄, further components may, of course, be provided to determine the controlling moment M_{Total}; this is indicated by a component Mₓ in FIG. 1.

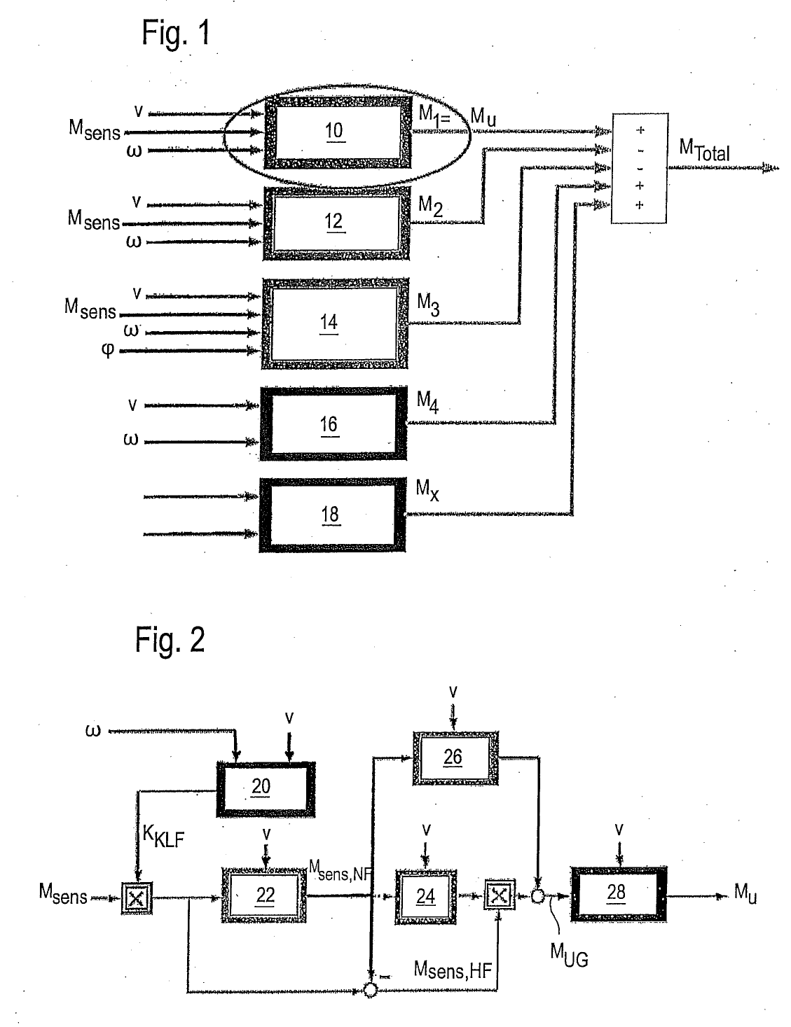

Referring to FIG. 2, the processing procedure 10 for establishing the first component M₁ in determining the controlling torque M_{Total} will now be discussed in detail below, that is, the method of determining the assist torque set-point value M_{U}=M₁ for an electromechanical power steering system. Input quantities that are initially sensed here are the steering torque Mₛₑₙₛ, the vehicle speed v, and the motor angular velocity ω (or, as an alternative, the steering rate v_{φ}).

In a further method step, a characteristic map output quantity K_{KLF} is determined from a predefined characteristic map 20. In the exemplary embodiment according to FIG. 2, the predefined characteristic map 20 is a two-dimensional characteristic map from which a weighting factor K_{KLF} is determined as the characteristic map output quantity in dependence on the vehicle speed v and the motor angular velocity ω.

In accordance with a first variant of the method of FIG. 2, the steering torque Mₛₑₙₛ sensed is multiplied by this weighting factor K_{KLF} and is subsequently divided up into a high-frequency portion M_{sens,HF} and a low-frequency portion M_{sens,NF} by a filtering device 22. The frequency division of the steering torque Mₛₑₙₛ by the filtering device 22 is effected here as a function of the vehicle speed v.

Then an assist torque base value M_{UG} is determined by means of the high-frequency portion M_{sens,HF}, a first predefined data table 24 into which the vehicle speed v and the low-frequency portion M_{sens,NF} of the steering torque Mₛₑₙₛ enter, and a second predefined data table 26 into which the vehicle speed v and the low-frequency portion M_{sens,NF} of the steering torque Mₛₑₙₛ enter.

According to FIG. 2, further provided is a stabilizing filter 28 that processes the assist torque base value M_{UG} as a function of the vehicle speed v in a further method step to finally output the assist torque set-point value M_{U}.

This assist torque set-point value MU enters into the calculation of the controlling torque M_{Total} as the first torque component M₁ (cf. FIG. 1). Finally, the electric motor of the electromechanical power steering system is then controlled in such a way that it applies the calculated controlling torque M_{Total}.

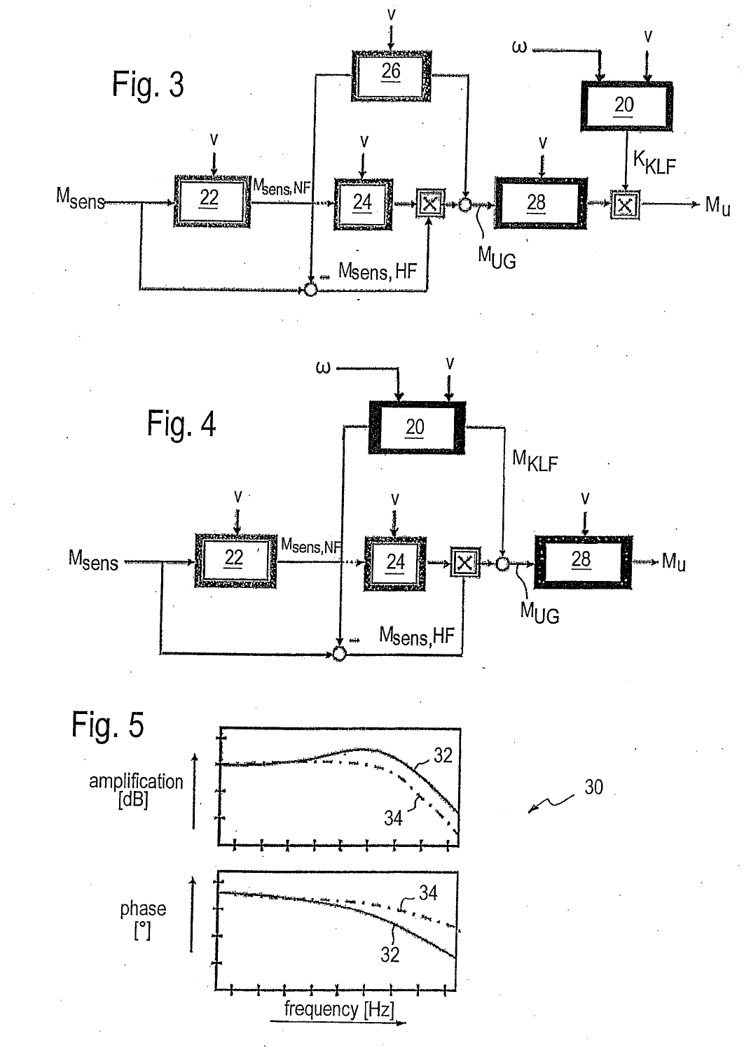

FIG. 3 shows a second variant of the method for determining the assist torque set-point value M_{U}, which differs from the first variant of the method according to FIG. 2 merely in that the weighting factor K_{KLF} determined as a characteristic map output quantity is taken into account in a different method step. While in the first variant of the method according to FIG. 1 the characteristic map output quantity K_{KLF} is multiplied by the sensed steering torque Mₛₑₙₛ as early as at the start of the method and a correspondingly weighted value of the steering torque Mₛₑₙₛ passes through all further steps in the method, in the second variant of the method according to FIG. 3 the characteristic map output quantity K_{KLF} is not considered until towards the end of the method when the assist torque base value M_{UG} has already been determined from the sensed steering torque Mₛₑₙₛ. Specifically, in this case it is therefore not the steering torque Mₛₑₙₛ, but only the assist torque base value M_{UG} that is multiplied by the weighting factor K_{KLF} after a processing by the stabilizing filter 28.

FIG. 4 shows a third variant of the method for determining the assist torque set-point value M_{U}, which differs from the method variants already described mainly in that the predefined characteristic map 20 is a three-dimensional characteristic map. In dependence on the vehicle speed v, the motor angular velocity ω, and the low-frequency portion M_{sens,NF} of the steering torque Mₛₑₙₛ as the input quantities, a partial torque M_{KLF} is determined as the characteristic map output quantity from this three-dimensional characteristic map 20. Expressed in simpler terms, in the exemplary embodiment according to FIG. 4 the two-dimensional characteristic map 20 and the second data table 26 (cf. FIGS. 2 and 3) have been combined to form the three-dimensional characteristic map 20 for the purpose of simplification and acceleration of the method.

The high-frequency portion M_{sens,HF} of the steering torque Mₛₑₙₛ is processed by analogy with the first two variants of the method and enters into the calculation of the assist torque base value M_{UG} along with the partial torque M_{KLF}. After passing through the stabilizing filter 28, the assist torque base value M_{UG} finally results in the assist torque set-point value M_{U} for the electric motor driven power steering system, just as in the first variant of the method according to FIG. 2.

FIG. 5 shows a Bode plot 30 illustrating the advantages of the method variants described. The Bode plot 30 is composed of an amplitude response (top of FIG. 5) and a phase response (bottom of FIG. 5), with solid diagram curves 32 each being associated with a conventional method of determining the assist torque set-point value M_{U} (without taking the motor angular velocity ω into account) and dash-dot diagram curves 34 each being associated with the method according to the invention of determining the assist torque set-point value M_{U}. The Bode plot 30 is based on a transfer function

$$\vert G ( j {ω}_{ϕ} ) \vert = \vert \frac{ϕ ( j {ω}_{ϕ} )}{{M}_{sens} ( j {ω}_{ϕ} )} \vert ,$$

where φ is the steering wheel angle and Mₛₑₙₛ is the steering torque sensed. The Bode plot 30 here illustratively reproduces the steering behavior of the power steering system with an input of sinusoidal steering maneuvers that become more rapid.

The amplitude response shows that the method according to the invention (curve 34) provides a substantially constant amplification which will drop in the desired manner only in the case of high steering maneuver frequencies. Any undesirable increase in the amplification at medium frequencies (cf. curve 32) can no longer be recognized.

In the phase response it becomes clear that in the dash-dot curve 34, as compared with the solid curve 32, a phase distortion is greatly minimized. The phase proceeds virtually constant over wide frequency ranges and will not drop significantly until in steering maneuvers at a high frequency.

All in all, the changes in the amplitude and phase responses of the Bode plot 30 are evidential of the fact that the determination of the assist torque set-point value M_{U} by the method according to the invention results in the driver experiencing an enhanced steering feel.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A method of determining an assist torque set-point value for an electric motor driven power steering system, comprising the steps of:
(a) sensing a steering torque;
(b) sensing a vehicle speed;
(c) sensing an angular velocity of the steering system electric motor;
(d) determining a characteristic map output quantity from a predefined characteristic map at least as a function of said vehicle speed and said motor angular velocity;
(e) determining said assist torque set-point value for said power steering system proceeding from said steering torque sensed, taking into account said characteristic map output quantity.

2. The method according to claim 1, wherein a filtering device is provided by which said steering torque is divided into a high-frequency portion and a low-frequency portion.

3. The method according to claim 2, wherein a frequency division of said steering torque being effected by said filtering device depends on said vehicle speed.

4. The method according to claim 2, wherein an assist torque base value is determined by means of given data tables into which said respective vehicle speed and said respective low-frequency portion of said steering torque enter.

5. The method according to claim 4, wherein a stabilizing filter is provided which filters said assist torque base value as a function of said vehicle speed.

6. The method according to claim 4, wherein said assist torque base value is multiplied by said characteristic map output quantity to determine said assist torque set-point value.

7. The method according to claim 5, wherein said assist torque base value is multiplied by said characteristic map output quantity after filtering said assist torque base value by said stabilizing filter.

8. The method according to claim 2, wherein said steering torque sensed is multiplied by said characteristic map output quantity before said frequency division by said filtering device.

9. The method according to claim 1, wherein said predefined characteristic map in step (d) is a two-dimensional characteristic map with said vehicle speed and said motor angular velocity as input quantities, a weighting factor being determined as said characteristic map output quantity.

10. The method according to claim 2, wherein said predefined characteristic map in step (d) is a three-dimensional characteristic map with said vehicle speed, said motor angular velocity, and said low-frequency portion of said steering torque as input quantities.

11. The method according to claim 10, wherein an assist torque base value is determined by means of a given data table into which said vehicle speed and said low-frequency portion of said steering torque enter, and by means of said predefined characteristic map into which said vehicle speed, said motor angular velocity, and said low-frequency portion of said steering torque enter.

12. The method according to claim 10, wherein a stabilizing filter is provided which filters said assist torque base value to determine said assist torque set-point value as a function of said vehicle speed.
